(19) United States
(12) Patent Application Publication
(10) Pub. No.: US 2026/0244982 A1
(43) Pub. Date: Aug. 20, 2026

(54) NO-CODE AI ASSISTANT SYSTEM WITH GGC FRAMEWORK

(71) Applicant: Techolution Consulting LLC, New York, NY (US)

(72) Inventor: Luv Tulsidas, New York, NY (US)

(73) Assignee: Techolution Consulting LLC, New York, NY (US)

(21) Appl. No.: 19/057,844

(22) Filed: Feb. 19, 2025

(51) Int. Cl. G06N 20/00

(52) U.S. Cl. CPC G06N 20/00

(57) ABSTRACT

The No-Code AI Assistant System is provided, which enables organizations to create, customize, and deploy AI assistants effortlessly, leveraging a unique Governance, Guidance, and Control GGC framework.

The primary feature of the system is the GGC framework, which includes three core components: Governance ensuring traceability of queries, sources of answers, and decision-making processes; Guidance which incorporates a second-opinion mechanism that learns from the organization's unique content, enhancing the accuracy and relevance of generated responses; and Control allowing human experts to review, approve, or modify AI-generated answers in real time, acting as a real-time AI coach.

The system may further include a Specific Purpose Transformer SPT that functions as a second-opinion evaluator. The SPT is exclusively trained on the organization's internal content, such as policies, FAQs, and historical responses. This focused approach enables the SPT to evaluate the relevance and accuracy of AI-generated responses in real time. If it detects low confidence in a response, it triggers a human review process, ensuring that only validated and contextually appropriate information is disseminated.

### FIELD OF THE INVENTION

The present application relates to artificial intelligence systems for deploying and managing artificial intelligence assistants in enterprise environments. Specifically, the invention pertains to a no-code platform for implementing AI assistants with integrated governance, guidance, and control capabilities.

### BACKGROUND OF THE INVENTION

An artificial intelligence AI assistant is a software program that uses artificial intelligence and natural language processing to perform tasks, answer questions, and provide support, often through voice commands or text input. AI assistants are designed to mimic human-like interactions and can perform a range of functions such as managing schedules, answering inquiries, providing recommendations, and handling customer service requests.

Enterprise adoption of artificial intelligence AI assistants has become increasingly critical for maintaining competitive advantage in modern business environments. These AI systems are deployed to automate customer interactions, streamline internal processes, and augment human capabilities across organizations. However, current implementation approaches present significant challenges that impede effective deployment and management.

Traditionally, AI systems used in enterprises operate with limited transparency, often lacking mechanisms to trace decision-making processes, data sources, and response generation pathways. This opacity can lead to a loss of control, making it challenging for organizations to ensure that AI outputs are consistent with internal policies and industry regulations.

Furthermore, real-time human intervention in AI responses is rarely available, resulting in AI-generated decisions that may not always reflect the most accurate or contextually appropriate information.

Current AI assistant solutions to such problems often demand considerable technical expertise for setup and customization, posing barriers for many organizations.

Furthermore, existing platforms typically lack essential features for real-time human intervention, adaptive learning, and comprehensive data integration, which limits their effectiveness in fast-paced environments. The reliance on third-party management for customization and maintenance can further escalate operational costs and reduce organizational control over AI systems.

In addition to the above, existing systems lack traceability, making it difficult to track how and why specific decisions were made.

Without proper governance, AI can operate unchecked, leading to decisions that are misaligned with company policies. The absence of review mechanisms makes it challenging to prevent or mitigate incorrect responses proactively.

These limitations collectively create significant obstacles for organizations seeking to implement AI assistants effectively. The combination of technical complexity, inadequate controls, and limited adaptation capabilities makes it difficult for organizations to realize the full potential of AI technology while maintaining necessary oversight and control.

There is an increasing demand for AI systems that are both adaptive and accountable, providing enterprises with the ability to manage AI assistant outputs proactively while retaining control over proprietary information and compliance standards.

To overcome these challenges and advance the state of the art, there is a pressing need to provide a no-code AI assistant platform that integrates a Governance, Guidance, and Control GGC framework. The GGC framework is designed to bring transparency, accuracy, and human oversight to AI-generated responses.

### SUMMARY OF THE INVENTION

The present invention is directed to a no-code AI assistant platform featuring a comprehensive Governance, Guidance, and Control GGC framework.

The present system empowers organizations to design, deploy, and manage AI assistants without specialized programming expertise, providing complete control over AI operations, while ensuring transparency, accountability, and alignment with organizational standards.

In an preferred embodiment of the present invention, the AI Assistant System, includes a governance, guidance, and control architecture including a governance module configured to ensure transparency and accountability by providing traceability of AI queries, data sources, and decision-making processes; a guidance module designed to evaluate AI-generated responses in real-time using organization-specific knowledge and a control module that enables real-time human intervention in AI operations.

In another embodiment of the present invention, the control module includes a Specific Purpose Transformer SPT that serves as a second-opinion evaluator and is programmed to detect low-confidence responses. If it identifies a response with low confidence, it activates a triggering mechanism, initiating an immediate human review process through the control module.

In another embodiment of the present invention, the control module acts as the primary interface for human operators, the control module enables real-time human intervention in AI responses, allowing human experts to review, approve, or modify AI-generated answers as needed.

In another embodiment of the present invention, the system includes a triggering mechanism within the guidance module that identifies low-confidence responses and automatically initiates human review through the control module.

In another embodiment of the present invention, the system includes a conditional logic mechanism When to Apply that dynamically determines the appropriate action or response based on the context of a user query. This mechanism plays a critical role in ensuring that the AI or system provides accurate and relevant responses while efficiently utilizing specialized tools or AI assistant agents.

In another embodiment of the present invention, the system includes a feature called AI trace, which allows transparency in how the system reaches its conclusions. This trace allows users to understand how an answer was generated, providing insights into the inner workings of the system and improving debugging and optimization.

In yet another embodiment of the present invention, the system includes an intuitive user interface that provides a cohesive and user-friendly experience, enabling operators to monitor AI activities, implement feedback, and manage interventions efficiently.

In yet another embodiment of the present invention, the governance module maintains a trace log of all AI decisions, including timestamps, data sources, and confidence scores for each response.

It should be noted that while the present invention has been described with reference to fasteners, it is not limited to this particular type of manufactured object and can be adapted to inspect other types of objects as well. Additionally, various modifications and alterations to the system and method may be possible without departing from the scope of the invention

### BRIEF DESCRIPTION OF THE DRAWINGS

The foregoing summary, as well as the following detailed description of various embodiments, is better understood when read in conjunction with the drawings provided herein. For the purposes of illustration, the drawings disclose subject matter which is not limited to the specific methods and instrumentalities disclosed. Further, the advantages and features of the present disclosure will better understood with reference to the following detailed description and claims taken in conjunction with the accompanying drawing, wherein like elements are identified with like symbols, and in which:

FIG. 1 illustrates the architectural diagram of the GGC Framework, according to an embodiment of the present invention.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like which are synonymous with “including,” “having” and “characterized by” may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

Further, the use of terms “first”, “second”, and “third”, and the like, herein do not denote any order, quantity, or importance, but rather are used to distinguish one element from another.

The term “No Code” refers No-code here refers to the ability to create AI

Assistant, ingest related documents and use GGC policy from user interface without the need of writing any code at all to achieve the same.

In one embodiment the present application introduces a no-code AI Assistant System, designed to empower organizations in deploying, managing, and supervising AI-powered assistants.

The invention may leverage a Governance, Guidance, and Control GGC architecture that aligns AI operations with organizational standards and regulatory frameworks, offering a user-friendly approach to AI management without specialized technical skills.

The system 100 may include three modules. First is a governance module 109 that is fundamental to ensuring transparency and accountability across AI operations. It operates as the system's oversight layer, responsible for maintaining a trace log 111 of all AI interactions and decisions.

This trace log 111 provides an auditable record, documenting each AI decision with the following components including timestamps; data sources and confidence scores.

Every action, response, or decision is time-stamped, ensuring that users can track the exact moment an interaction or decision took place.

Each response is mapped to its original data source, allowing users to understand the origin of the information provided by the AI assistant. This feature promotes transparency by enabling users to verify the relevance and reliability of data sources.

This module 109 preferably assigns a confidence score to each AI response, which quantifies the system's 100 certainty regarding the provided answer. Responses with lower confidence scores are flagged for human review to maintain a high level of response accuracy.

The Governance Module 109 serves as an intermediary between the AI system 100 and the human operators. It connects with the Control Module 116 to enable compliance checks and alert human experts when interventions are required.

The second module is the Guidance Module 102 that provides the AI assistant with domain-specific expertise, enhancing its ability to respond accurately within the organization's context. This module 102 focuses on learning and improving responses over time.

Furthermore, this module acts like an inbox wherein the user can review questions and AI-generated answers, then accordingly provide feedback to correct inaccuracies. The corrections are remembered for future interactions.

The Guidance Module 102 includes a built-in triggering mechanism, programmed to flag low-confidence responses. When the Specific Purpose Transformer SPT identifies a response that does not meet a pre-set confidence threshold, it signals for immediate human intervention via the Control Module 102. This real-time assessment capability adds a layer of safety, allowing the AI system to operate effectively even in high-stakes environments.

Third is the Control Module 116 that functions as the primary interface for human operators, providing them with tools for real-time supervision and intervention in AI responses. The Control Module 116 allows for a range of interactions.

This module includes a Specific Purpose Transformer SPT, designed to process and evaluate AI responses in real time. The SPT is trained exclusively on the organization's internal resources, such as policies, knowledge bases, historical data, and proprietary documents. This focused training ensures that the AI responses align with internal standards, thus reducing inaccuracies caused by generic or irrelevant data. The SPT continuously evaluates AI-generated responses for relevance and accuracy.

Furthermore, this module 102 preferably operates in real time, ensuring the quality of responses by involving a human expert when the AI's confidence is low or the response needs review. Users are notified when an answer is pending human validation.

Human operators can review, approve, or modify AI-generated responses before they are presented to end-users. This capability enables operators to align responses with organizational policies and correct any inaccuracies or context mismatches in real time.

Each interaction with human experts generates insights that are logged and fed back into the system as part of a feedback loop. This continuous learning process allows the AI model to adjust over time, improving its ability to respond accurately to similar queries in the future. This iterative feedback mechanism enhances the model's alignment with evolving organizational needs and standards.

The Control Module's 116 interface supports real-time notifications, alerting human operators when a flagged response needs immediate attention.

The Control Module 116 is designed with a user interface 119 that allows operators to monitor AI activities seamlessly. This interface 119 consolidates all AI activities, providing an intuitive and efficient view of flagged responses, intervention history, and logged feedback.

The system may include a Triggering Mechanism within the Guidance Module 102. This mechanism operates as a continuous confidence monitor, assessing each AI response for accuracy and reliability. When a response fails to meet the predefined confidence level, the Triggering Mechanism is activated, escalating the response for human review via the Control Module.

The evaluation framework for assessing the quality of a response based on four equally weighted criteria: Completeness, Correctness, Information Overlap, and Relevancy. Each criterion is scored out of 10, contributing 25% to the overall evaluation. Completeness evaluates whether the response fully addresses the user's question with all necessary information from the context. Correctness ensures the response is accurate and aligns with the provided context. Information Overlap measures how well the response incorporates information directly from the context. Relevancy assesses whether the response is directly related to the user's query.

The response in this evaluation received a perfect score of 10/10 in all categories, resulting in a flawless overall score of 100%. This indicates the response was comprehensive, accurate, contextually aligned, and highly relevant.

If a flagged response remains unresolved for a specified period, the mechanism escalates the query to higher-level human supervisors. This ensures a timely response to urgent or complex queries, adding another layer of reliability to the system's operations.

The User Interface 119 is designed to facilitate seamless operator interaction with the system 100. It provides a cohesive, user-friendly experience that enables operators to monitor AI activities, respond to flagged interactions, and implement feedback efficiently.

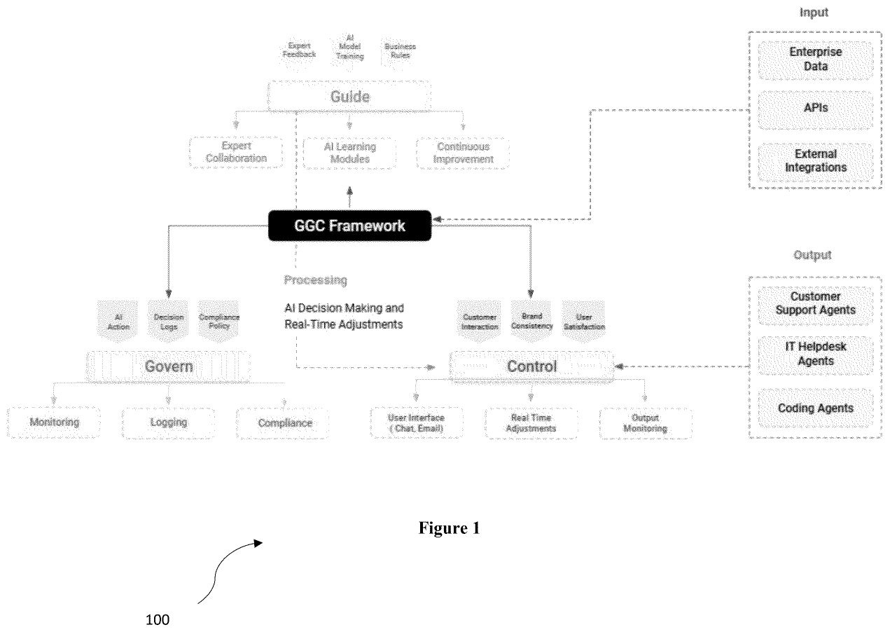

FIG. 1 illustrates the comprehensive architecture of the Governance, Guidance, and Control GGC Framework.

This architecture implements a three-tier system that processes organizational inputs, applies multi-layered controls, and delivers specialized outputs.

The GCC Governance, Control, and Compliance Framework 101 is a robust, multi-layered architecture designed to effectively manage AI systems. At its core, the framework serves as the central processing engine, surrounded by interconnected layers, each fulfilling specific roles within the AI governance ecosystem.

The topmost layer in the system 100 is the Guide Layer 102 that provides strategic oversight and direction to the AI system, ensuring alignment with organizational goals.

The Guide Layer 102 comprises three critical components: Expert Feedback 103, which enables human oversight by incorporating expert insights to guide AI operations and maintain accountability; AI Model Training 104, which focuses on continuous improvement of the AI's learning models to ensure adaptability to evolving requirements and data trends; and Business Rules 104, which define the operational parameters and boundaries to ensure compliance with organizational policies and objectives. Together, these components establish a high-level governance structure that aligns the AI system with business needs.

The Processing Layer 105 bridges strategic guidance from the Guide Layer with operational execution. This layer includes Expert Collaboration 106, which facilitates seamless interaction between human experts and AI systems to foster synergy in decision-making; AI Learning Modules 107, which house the core machine learning algorithms that enable the system to learn, adapt, and improve over time; and Continuous Improvement 108, which implements feedback loops to allow dynamic evolution based on performance insights and new data. This layer acts as the functional hub, translating high-level directives into actionable AI processes.

On the left side of the system 100 incudes the Govern Section 109 that focuses on oversight, regulatory compliance, and risk management.

The primary components include AI Analytics 110, which monitors system performance metrics to ensure efficiency and identify areas for improvement; Decision Logic 111, which implements predefined rules for consistent decision-making; and Compliance Policy 112, which ensures adherence to industry regulations and organizational policies.

Supporting these components are Monitoring 113 for real-time oversight, Logging 114 for maintaining detailed records of system activities, and Compliance 115 to ensure ongoing alignment with regulatory requirements and ethical standards.

On the right side of the system 100 includes the Control Section (Module) 116 that manages operational execution and user interactions.

The key components of this module 116 includes Customer Interaction 117 to enhance user experience through AI-driven communication, Brand Governance 118 to align AI actions with the organization's values and protect its image and User Satisfaction 118 to monitor and improve user experiences via feedback and adjustments.

Additional components include User Interface 119 to handle communication channels for seamless interaction between users and AI, Real-Time Adjustments 120 to enable dynamic modifications based on real-time data and feedback, and Output Monitoring 121 to ensure quality, accuracy, and relevance of AI outputs. This components in the Control Module 116 ensures smooth and efficient interactions between the AI system and its users.

The framework also integrates various input sources 121 to feed data into the system for informed decision-making. These sources include Enterprise Data 122, which provides internal organizational data such as customer information and operational metrics; APIs 123, which connect the system with external applications and services; and External Integrations 124, which supply data and insights from third-party systems or external environments. These inputs ensure the AI operates with comprehensive and accurate information.

On the output side 125, the framework connects with key operational agents to facilitate human-AI collaboration. These include Customer Support Agents 126, who collaborate with AI to deliver effective customer service; IT Helpdesk Agents 127, who leverage AI insights to address technical issues; and Coding Agents 128, who work alongside AI systems to enhance software development processes. These outputs enable the AI system to support and enhance diverse operational workflows.

At the center of the framework lies the AI Decision-Making and Real-Time Adjustments component, which serves as the system's cognitive core. This component processes inputs from all sources, coordinates responses, and makes dynamic adjustments in real-time. It ensures all decisions and actions are consistent with governance protocols, compliance standards, and business objectives, maintaining the reliability and alignment of the system across all layers.

A computer program product, embodied on a non-transitory computer-readable medium, configures an AI system to deploy and manage adaptive AI assistants for enterprises using a Governance, Guidance, and Control (GGC) architecture.

It integrates input data from internal and external sources, including enterprise datasets, APIs, and external systems, to enable AI-driven decision-making and real-time response generation.

The product leverages a Specific Purpose Transformer (SPT) model trained exclusively on internal organizational content to ensure the relevance and accuracy of AI responses, with human expert intervention triggered for low-confidence outputs, allowing real-time corrections and enhanced decision-making.

The program incorporates mechanisms for input data integration, including organizational policies, procedures, FAQs, customer data, and external real-time data streams such as weather or market updates.

The Governance module ensures adherence to regulatory and business standards through monitoring, logging, and compliance policies.

Additionally, the Guidance module supports AI learning by incorporating feedback from subject-matter experts, enabling continuous improvement in AI accuracy and alignment with enterprise-specific content.

A user interface allows for direct human oversight, enabling users to review, approve, or modify AI-generated responses in real time.

Output monitoring and logging mechanisms continuously track AI interactions, facilitating performance enhancement and compliance over time. This ensures the AI system adapts to evolving enterprise needs while maintaining high levels of control, accountability, and accuracy.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

1. An AI Assistant System configured to generate AI responses to queries, the system comprising;
a governance, guidance, and control architecture, further comprising:
a governance module, wherein the governance module is configured for transparency and accountability by maintaining trace logs of AI queries, data sources, and decision-making processes to generate the AI responses;
a guidance module, wherein the guidance module provides the AI assistant system with domain-specific expertise, focusing on learning and improving responses;
a control module, wherein the control module acts as a primary interface for human operators, facilitating continuous improvement of AI responses from the guidance module;
wherein the control module includes a Specific Purpose Transformer SPT that functions as a second-opinion evaluator to assess relevance and accuracy of AI-generated responses in real time;
a triggering mechanism within the guidance module, wherein the triggering mechanism is configured to identify low-confidence responses and automatically initiate human review through the control module;
a “When to Apply” mechanism to enhance the AI's system ability to provide accurate and context-aware responses, operates through a structured process that begins with analyzing the input context; and
an user interface, providing a cohesive and user-friendly experience, enabling operators to monitor AI activities, implement feedback, and manage interventions.

2. The system of claim 1, wherein in the guidance module, guidance feature on user interface appears where the user can review questions and AI-generated answers and provide feedback to correct inaccuracies.

3. The system of claim 1, wherein when to apply mechanism analyzes the input context and the AI system evaluates various elements of the query, including its structure, keywords, phrasing, and underlying intent, to extract meaningful insights.

4. The system of claim 1, wherein the system comprises a feedback loop within the control module, wherein provided by human experts are used to continuously train and improve the AI model's future responses,.

5. The system of claim 1, wherein there is a No-Code Customization Mechanism within the system that enables organizations to modify AI assistant behavior and deploy new AI configurations without specialized programming knowledge.

6. The system of claim 1, wherein the system enables organizations to create, customize, and deploy AI assistants effortlessly via the Governance, Guidance, and Control GGC framework architecture.

7. The system of claim 1, wherein the user interface supports notifications to alert human experts when a flagged AI response requires immediate attention.

8. The system of claim 1, wherein the trace log includes timestamps, data sources, and confidence scores for each response to facilitate auditing and analysis.

9. The system of claim 1, wherein the system automatically escalates unresolved flagged queries to higher-level human supervisors if no action is taken within a predefined period.

10. The system of claim 1, wherein the system includes an AI trace, which allows transparency in how the system reaches its conclusions, allowing users to understand how an answer was generated.

11. A computer program product embodied on a non-transitory computer-readable medium comprising instructions that, when executed by a processor, configure an AI system to deploy and manage adaptive AI assistants for enterprises, wherein the platform utilizes a Governance, Guidance, and Control GGC architecture, the computer program product comprising instructions to:
integrate input data from internal and external sources, including enterprise datasets, APIs, and external systems, to inform AI decision-making processes;
facilitate AI-driven decision-making and real-time response generation through the GGC architecture of claim 1;
train and deploy a Specific Purpose Transformer SPT model exclusively on the organization's internal content to assess the relevance and accuracy of AI-generated responses in real-time;
trigger human expert intervention when the SPT detects low confidence in AI-generated outputs, thereby facilitating real-time corrections; and
provide output monitoring and logging mechanisms to continuously track AI interactions and improve the performance and compliance of the AI system over time.

12. The computer program product of claim 11, wherein the input data includes organizational policies, procedures, FAQs, and customer data to ensure the AI system's responses align with enterprise-specific content.

13. The computer program product of claim 11, wherein APIs provide real-time external data streams, including third-party knowledge bases and real-time updates such as weather or market data.

14. The computer program product of claim 11, wherein the Governance module further comprises monitoring, logging, and compliance policies to ensure the AI system adheres to regulatory or business standards.

15. The computer program product of claim 11, wherein the Guidance module facilitates AI learning by incorporating continuous feedback from subject-matter experts.

16. The computer program product of claim 11, wherein a user a user interface, enabling them to review, approve, or modify AI-generated responses in real time.
